(19) United States
(12) Patent Application Publication
(10) Pub. No.: US 2016/0304245 A1
(43) Pub. Date: Oct. 20, 2016

(54) ACCESSORY FOR CLOTH APPLICATOR

(71) Applicant: Carl Albert BEADLE, Brisbane, Queensland (AU)

(72) Inventor: Carl Albert BEADLE, Brisbane (AU)

(21) Appl. No.: 15/102,050

(22) PCT Filed: Dec. 5, 2014
(86) PCT No.: PCT/AU2014/001096

§ 371 Date: Jun. 6, 2016

(30) Foreign Application Priority Data
Dec. 6, 2013 (AU) 2013904750

(51) Int. Cl. B65D 23/12; A47L 13/16; B05B 11/00; A47L 13/51

(52) U.S. Cl. CPC B65D 23/12; A47L 13/51; A47L 13/16; B05B 11/3014; B05B 11/3042

(57) ABSTRACT

A container which in this case is a pump action bottle 10 has a container body 11 and a lid 12 including a pump portion 13 a nozzle 14 a trigger 15 and a neck section, shown generally at 16. It has an accessory in with a cloth keeper 17 clipped to the neck by reason of resilient legs 18, 19 which have a narrow entrance at 20 and an internal spacing slightly less than the outside diameter of the neck 16. Thus in the usual way of clips of this kind it may be pushed onto the neck and snap into position. The keeper 17 has a cylindrical eyelet 21 so that a rag 22 may be drawn from below through the eyelet and as the rag gathers it will wedge in position. The rag may be easily removed simply by pulling downward in the direction of arrow 23. The rag may be kept with the bottle when stored.

### FIELD OF THE INVENTION

THIS INVENTION relates to an accessory for a cloth applicator of the type used to apply cleaning liquids or the like and in particular but not limited to a cloth keeper used in combination with a cleaning cloth and container of cleaning liquid.

### BACKGROUND

Cleaning, polishing and other similar treatments often involve application of an active agent held in container, the container being stored away between applications. Active agents are in spray applied liquids, wipe on gels, powders and so on. Cloth is often used to apply or wipe a surface during a treatment. Sometimes the cloth is disposed of after a single use but on most occasions cloths are used over and over again. Households usually have different cleaning agents for different purposes. For example, one agent is typically used for windows, another for timber and still another for bathroom tiles. Where different cleaning agents are use the householder frequently has a cloth for each. Under present arrangements it is easy to lose track of which cloth was used with which agent during the previous application. Sometimes cloths are misplaced altogether. Cloths are often stored together in a bundle and this adds to the confusion as to which cloth is appropriate. Also different people in a household may use the cleaning agents at different times making cloth selection even more difficult. This whole situation is inconvenient.

The following documents were cited in the International Type Search report conducted by the Australian Patent Office on the search statement submitted with the search request in respect of the applicant's Australian provisional patent application No. 2004906478. DE29708202U1 (CHEN); FR2746375A1 (CANAVESE et al.); JPH08258845A (HIROHAMA); WO0166418 (LEE); WO04026733 (BLANCHESTER); and WO09406490 (BAHR). According to the International Type Search report none of these “disclose accessories for containers for holding cloths”, but according to the report “disclose accessories which are suitable for use with containers and are capable of holding cloths”.

CHEN describes a cap and handle for a sports drink bottle. The cap fits over and closes the spout of the drink bottle. The cap has a tab a finger ring. The cap and its ring must be separated from the bottle to dispense the contents of the drink bottle. The ring could hold a cloth but the cap has to be removed to dispense the contents so the cap could be lost.

CANAVESE et al. describes wine bottle stopper holder. It has a large ring with a smaller c-shaped projection, the large ring slides axially over the neck of a wine bottle. The large ring has an inner foam surface. The c-shaped projection permits the bottle stopper to be clipped to the bottle when uncorked. The c-shaped projection could hold a cloth. The opening in the C-shaped projection would make this unreliable in holding a cloth.

HIROHAMA describes a flexible spout for a threaded screw top oil container. The spout is secured by being fitted into a threaded open topped cap which substitutes for the oil container cap. A matching flexible projection on the spout body seals against the open topped cap and a circular locking cap which slides down over the spout and the locking cap axially clips onto a circular groove on the open topped cap. The locking cap clamps the projection. The locking cap has a horizontal extending ring tab that could hold a small cloth. As for LEE below the ring appears to be too small to reliably hold a cleaning cloth.

LEE describes a spout for a beverage can, the can has a cap C with a finger grip C5 used to enable a user to pull the cap off. The ring C5 could hold a cloth although it is doubtful that it could reliably hold a cleaning cloth.

BLANCHESTER describes a carrying device for a bottle. The carrying device has a ring and a hook. These are the same size and fold over one another so their axes are aligned. The device is retained about the neck of a bottle by the bottle cap preventing the ring from sliding off. The hook section folds over the bottle aligned with the centre of the cap and prior to use is retained on the bottle in this folded position and the hook is pulled out to be used as a handle. The hook when in it's pulled out position could hold a cloth although it is doubtful that it could reliably hold a cleaning cloth.

BAHR relates to medical equipment and describes a disposable stand for infusion sets. C-shaped side support brackets fit on a rod like stand and hold variously an infusion bag and tubes. It is not clear how this applies to the present invention.

The following documents were cited during examination of the Applicant's corresponding New Zealand patent application No. 630927, U.S. Pat. No. 6,540,11B1 (BENSUSSAN et al.); U.S. Pat. No. 3,299,442 (WHITE et al.); and U.S. Pat. No. 5,960,973 (MARKSON)

BENSUSSAN et al. describes a spray bottle holder assembly for use with a bottle, a hose and a spray pump or trigger. The holder assembly has a threaded cap to replace the threaded cap of a bottle and be retained on the bottle when the bottle screw top is replaced by the holder assembly. The holder is a quite complex unit with various functions one of which in FIG. 9 is a ring used to hold a rag. Importantly, the contents of the container passes through the threaded cap of the holder assembly.

WHITE et al. describes a bottle with a hanger support for medical use. It includes a handle with a finger opening so the bottle may be carried. The finger opening could be used to store a cloth although it is doubtful that it could reliably hold a cleaning cloth.

MARKSON describes clip to retain a snake pack to a beverage container. In one embodiment as applied to a drink bottle a scalloped ring fits over the bottle neck and a tab hangs down beside the bottle, the tab has clip device and the snack pack is secured by it to hang down along the side of the drink bottle. A cloth could be secured in place of the snack pack.

As demonstrated by this prior art the art of devices to hold all manner of things which without modification could be used to hold a rag or cleaning cloth are readily available and have been known but these are either too complex BENSUSSAN et al or have not received ready acceptance in the dual use capability envisaged in the International Type Search Report notwithstanding that in hindsight they could be used to hold a cloth it is doubtful that they would be considered a cloth keepers for the present purpose.

Consequently, there is a need for a simple solution to this age old problem. It is an object of the present invention to provide an accessory for a cloth type applicator so that the cloth type applicator may be conveniently stored with its corresponding agent.

Outline

In one broad form therefore the present invention resides in An accessory for a container holding an agent to be applied with a cloth type applicator, the container having a dispenser portion, the accessory having a cloth keeper to hold a cloth with the container while the container is in storage and permit removal of the cloth from the keeper so that the cloth may be used to apply the agent and then returned to the keeper, the keeper being adapted to fit the container without altering the operation of the dispenser portion.

In another aspect the invention resides in the combination of a container holding agent to be applied with a cloth type applicator, the container having a cloth keeper adapted to hold the cloth with the container while the container is in storage.

The container is typically any one of the common containers used in households for holding of liquids, gels, slurries and powders. Examples are pump action spray containers, aerosol containers and cans containing polish and so on.

The cloth type applicator may be a special purpose cleaning cloth or simply a rag adapted to the purpose in the usual way.

The keeper may be any means that enables the applicator to be positively retained with the container so that it may not be inadvertently separated from the container. The keeper may have hooks, loops, clips, rings, clamps or other means that may be used in order to achieve this objective. However, it is preferable that the keeper be a simple fastener free arrangement where the cloth may be held without the need of any specialised fastener. To this end the keeper preferably comprises at least one eyelet through which a cloth may be fed, the eyelet being so sized and dimensioned that the cloth may be manually drawn through the eyelet and thereby gathered by its progressively increasing bulk in the eyelet as it is pulled through to be wedged in the eyelet in a storage position and if needed the cloth may be released by pulling in the opposite direction.

The keeper may be formed integrally with the container, the container lid or it may be a separate device attached to the container later. Preferably, the keeper is a separate part securable to the container. Preferably, the keeper has a manual push on attachment that resiliently deforms and clips about part of the container. In another version the keeper is retained in place by the container lid.

The keeper is preferably adjustable in its position on the container. For example where the container includes triggers or other manually operable means for application of the agent it is preferable that the keeper be attached to the container so that its position may be adjusted for right handed or left handed use or to ensure that any mechanical parts of the container are still workable with the keeper in place. In a specially preferred form the keeper comprises an eyelet and a C shaped clip so that the keeper may be clipped around the neck of a bottle.

Typically, the accessory is one of a set of three adapted to fit bottles and there being a small size suited to the trigger type bottles, a large size suited to large spray cans and a size between the small and large suited to the smaller cans.

Typically, the container is a spay container having a manually operable spray control, the accessory having a lower surface, the lower surface tapers from a wide can contact surface up to a narrow edge providing a comfortable region for a user's hand while holding and operating the spray container.

Typically, the accessory is separable from the container and has an automatic locating device to secure the accessory relative to the container.

Typically, the accessory is separable from the container and has an automatic locating device to secure the accessory relative to the container, the locating device comprising one or more slots spaced around and inner surface of the accessory and being adapted to be in register with an edge of the container.

Typically, the accessory is separable from the container and has an automatic locating device to secure the accessory relative to the container, the locating device being so made an arrange to automatically set the position of the keeper relative to operation of the container.

### BRIEF DESCRIPTION OF THE DRAWINGS

In order that the invention may be more readily understood and be put into practical effect reference will now be made to the accompanying drawings which illustrate a number of preferred embodiments of the invention and wherein:

FIG. 1 is a perspective drawing illustrating a pump action spray bottle fitted with a keeper in accordance with the present invention;

FIG. 2 is a perspective drawing illustrating a keeper of the type illustrated in FIG. 1;

FIG. 3 is an embodiment similar to the embodiments FIGS. 1 and 2 but in this case is of larger diameter so that it may clip about an aerosol can;

FIG. 4 illustrates the use of a ring to stop the clip from sliding down on the can whereby in the embodiments of FIGS. 3 and 4 the clip is clipped above the ring;

FIG. 5 illustrates another embodiment whereby the keeper is formed as a pivoting keeper as part of a lid of an aerosol container;

FIG. 6 is a further embodiment whereby the keeper is in the shape of a FIG. 8 and is retained in place by the lid of the bottle;

FIG. 7 is an arrangement whereby the keeper is formed integrally with the lid as a moulded plastics unit effectively operating in a similar fashion to the embodiment of FIG. 3;

FIG. 8 is a magnetic keeper which is retained against a metal aerosol container by use of a magnet;

FIG. 9 shows a set of keepers that may typically be employed in a household for different spray containers, there being a small, medium and a large size;

FIG. 10 shows the large size being used on a larger sized spray can, the medium size being used on smaller spray cans;

FIG. 11 shows the small size being used on a trigger type spray bottle; and

FIGS. 12 and 13 are part views showing the engagement of the small size keeper with the neck of the spray bottle.

### METHOD OF PERFORMANCE

Referring to the drawings and initially to FIG. 1 there is illustrated in combination a container which in this case is a pump action bottle 10 having a container body 11 and a lid 12 including a pump portion 13 a nozzle 14 a trigger 15 and a neck section, shown generally at 16. A keeper 17 is clipped to the neck as illustrated by reason of resilient legs 18, 19 which have a narrow entrance at 20 and an internal spacing slightly less than the outside diameter of the neck 16. Thus in the usual way of clips of this kind it may be pushed onto the neck and snap into position as illustrated in FIG. 1. The keeper 17 has a cylindrical eyelet 21 so that a rag 22 may be drawn from below through the eyelet and as the rag gathers it will wedge in position as illustrated in FIG. 1. The rag may be easily removed simply by pulling downward in the direction of arrow 23. It will be appreciated in this arrangement that the rag may be kept with the bottle when stored and this will provide a solution to the problems outlined previously.

It will also be appreciated that the keeper 17 may be rotated around the neck of the bottle so that the position of the rag may be placed on the right or the left depending on whether the person using the bottle is right or left handed. It may also be placed in a position where it does not interfere with the operation of the trigger 15.

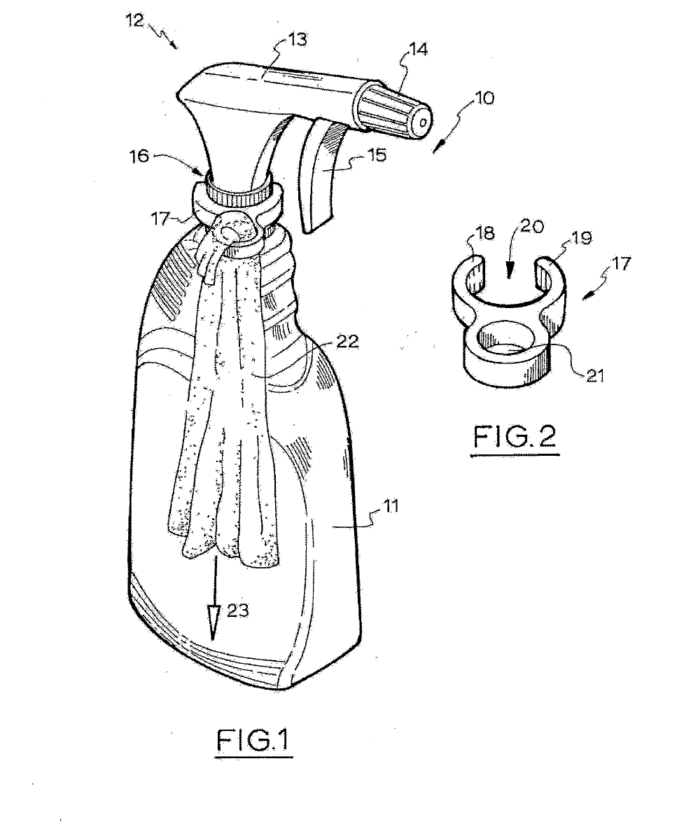

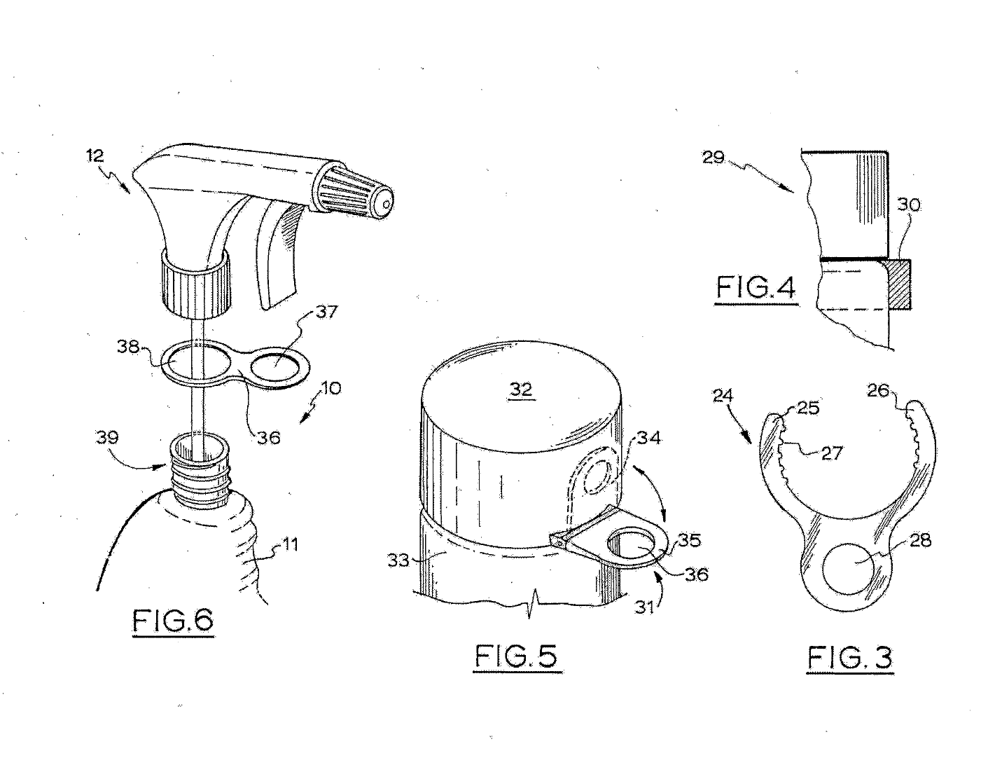

FIG. 3 illustrates an embodiment similar to FIG. 2 and in this case there is provided a keeper 24 having legs 25, 26 and including gripping ribs 27 and an eyelet 28. This particular embodiment is utilised on a cylindrical can or the plastic portions of a lid of a can which is shown at 29 in FIG. 4. In this case a circular ring 30 is fitted about the body of the can so that the keeper 24 may clip above the ring and therefore be removed with the lid. In the embodiments of FIGS. 2 and 3 the invention may be comprised as a set whereby the clipped diameters range from about 30 mm, about 50 mm and about 65 mm to cater for bottles such as the spray bottle of FIG. 1 and two common can sizes.

The cloth or rag hole size of the eyelet is typically 15 mm to 20 mm. These dimensions will of course vary depending on the size and configuration of the container and the size and type of material from which the rag or cleaning cloth is made.

FIGS. 5 and 6 illustrate further embodiments. In FIG. 5 a keeper 31 is hingedly connected to a lid 32 of an aerosol container 33 and may be moved between the position illustrated in phantom at 34 and the position illustrated at 35, it also includes an eyelet 36. The eyelet when positioned as illustrated in FIG. 5 is used in the same way as illustrated in FIG. 1.

FIG. 6 is an embodiment of another version of the present invention whereby a bottle 10 of the type illustrated in FIG. 1 utilises a figure eight type keeper 36 and this is retained in place on the bottle body 11 by the application of the lid 12. The keeper 36 has an eyelet 37 and a ring 38 which fits over the threaded top 39 of the bottle body 11 and when the lid is screwed down on the bottle the keeper is held in place.

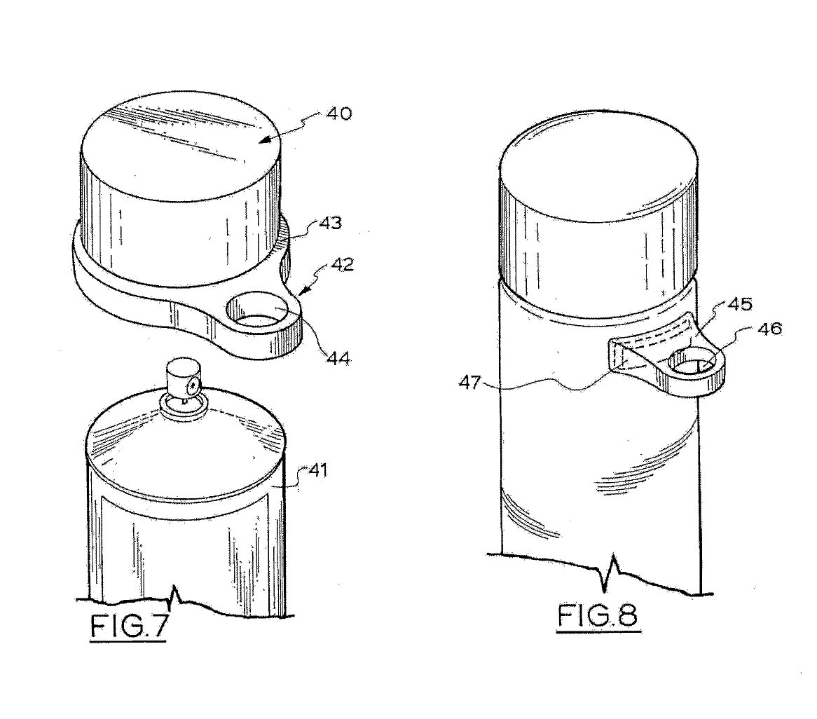

FIG. 7 illustrates a lid 40 on aerosol container 41 having a keeper 42 moulded as part of the lid 40. The keeper 42 includes a flange 43) running about the lid 40 and a projecting eyelet 44 which again operates in the same way as eyelets of the previous embodiments.

FIG. 8 is another embodiment and in this case there is provided a keeper 45 having an eyelet 46 and a magnetic insert shown in phantom at 47 so that the keeper is secured to the can utilising the magnet 47. The eyelet 46 operates in the same way as the previous embodiments.

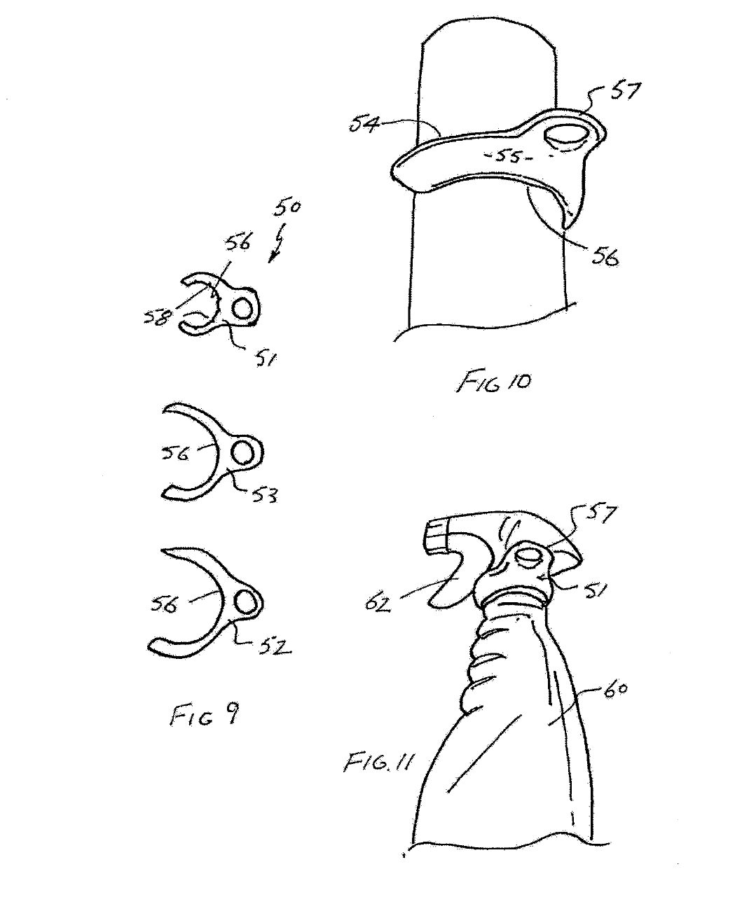

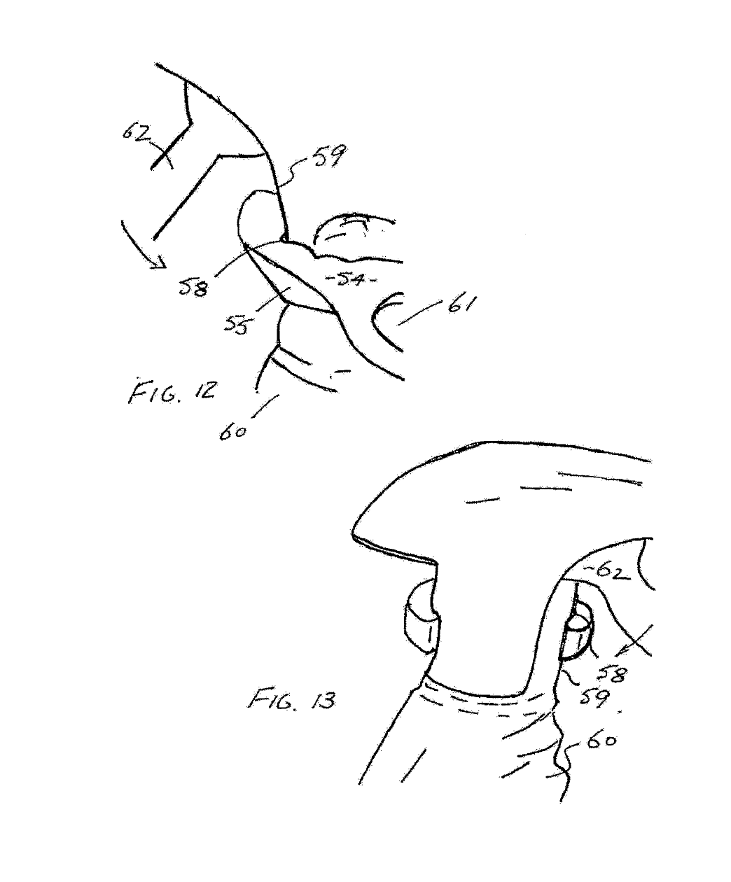

Referring to FIGS. 9 to 13 there is illustrated a further embodiment based on the embodiments of FIGS. 2, 3 and 4. In this case the keepers are provided as a set 50 of three to match the three common sized spray bottles and spray cans, so there is a small size 51 suited to the trigger type bottles, the large size 52 suited to large spray cans and a size between the small and large suited to the smaller cans. While a set is desirable the keepers may be sold individually or as a packed add on with the bottles and cans. Thus the use may make an initial purchase with the keeper but then simply unclip the keeper and but cans or bottles and ruse the keeper. This has a distinct advantage over the keepers that are made as part of the container or container lid.

Another feature of the keepers of FIGS. 9-13 is that the top surface 54 is flat and in use is horizontal on a standing bottle or can, the lower surface 55 tapers from a wide can contact surface 56 up to a narrow edge 57. This provides a comfortable region for the users hand while holding and operating the spray container, it being remembered that the in order to operate the spray control the hand must be close to the top of the can or bottle and in a position determined by the particular control. Thus the keepers for the can are able to slide around the can being made marginally smaller to clip and grip but still able to slide so that spraying may be accomplished with the keeper still in place.

FIGS. 12 and 13 highlight a difference for the small keeper, the small keeper having a series of slots 58 spaced around its surface 56. As can be seen in FIGS. 12 and 13 one of these slots 58 is in register with an edge 59 of the bottle 60 and as can be further seen in the drawing the keeper hole 61 is automatically set at 90 degrees to the line of operation of the trigger 62. Due to the other slots this may be set at a range of positions suited to the user and may be positioned for right or left handed use.

Whilst the above has been given by way of illustrative example of the present invention, it will be appreciated that many variations and modifications to the present invention will be possible and readily apparent to those skilled in the art without departing from the broad ambit and scope of the invention as set out in the appended claims.

1. A cloth keeper accessory when used with a hand held container holding an agent to be applied manually with a cloth type applicator, the container having a top and being a spray container having a manually operable spray control adjacent the top of the container, the accessory having a cloth keeper to hold a cloth with the container while the container is in storage and permit removal of the cloth from the keeper so that the cloth may be used to apply the agent and then returned to the keeper, the accessory being a separate part having an attachment securable to the container and when so secured a user may carry the container with the accessory fitted and still operate the control, the keeper being adapted to hold a cloth applicator by the cloth being manually drawn into the keeper so that the cloth gathers as it is drawn into the keeper.

2-15. (canceled)

16. An accessory according to claim 1, wherein the spray control is a pump action trigger extending below a spray nozzle the accessory having a manual sideways push on attachment that resiliently deforms and clips about part of the container, and its keeper being so dimensioned and arranged such that its manual push on attachment is located adjacent an upper part of the container and being adjustable so that it does not restrict operation of the control with the user's hand holding the container below the accessory while operating the control.

17. An accessory according to claim 1, wherein the keeper is a fastener free arrangement where the cloth may be held by passing through the keeper.

18. An accessory according to claim 1, wherein the keeper is a fastener free arrangement where the cloth may be held by passing through the keeper, the keeper comprises at least one eyelet through which a cloth may be fed, the eyelet being so sized and dimensioned that the cloth may be manually drawn through the eyelet and thereby gathered by its progressively increasing bulk in the eyelet as it is pulled through to be wedged in the eyelet in a storage position and if needed the cloth may be released by pulling in the opposite direction.

19. An accessory according to claim 1, having a manual sideways push on attachment that resiliently deforms and clips about part of the container, wherein the push on attachment comprises a clip having a pair of opposed legs opposite the keeper, the legs being separated at their respective ends by a narrow entrance.

20. An accessory according to claim claim 1, having a manual sideways push on attachment that resiliently deforms and clips about part of the container, wherein the push on attachment comprises a clip having a pair of opposed legs opposite the keeper, the legs being separated at their respective ends by a narrow entrance, the manual push on attachment being adjustable in its position on the container.

21. An accessory according to claim 1, having a manual sideways push on attachment that resiliently deforms and clips about part of the container, wherein the accessory comprises a keeper as an eyelet joined to the manual push on attachment, the manual push on attachment being a C shaped clip so that the accessory may be clipped around the neck of the container.

22. An accessory according to claim 1, having a manual sideways push on attachment that resiliently deforms and clips about part of the container wherein the accessory comprises a keeper as an eyelet joined to the manual push on attachment, the manual push on attachment being a larger C shaped clip so that the accessory may be clipped around the neck of the container, the accessory having a lower surface which tapers from a wide can contact surface up to a narrow edge.

23. An accessory according to claim 1, wherein the accessory is one of a set of three and there being a small size suited to trigger type bottles, a large size suited to large spray cans and a size between the small and large suited to smaller cans.

24. An accessory according to claim 1, wherein the container is a spray container having a manually operable trigger spray control, the accessory having a lower surface, the lower surface tapers from a wide can contact surface up to a narrow edge providing a comfortable region for a user's hand while holding and operating the spray container.

25. An accessory according to claim 1, having a manual sideways push on attachment that resiliently deforms and clips about part of the container, where the manual push on attachment has an automatic locating device to secure the accessory relative to the container.

26. An accessory according to claim 1, having a manual sideways push on attachment that resiliently deforms and clips about part of the container, where the manual push on attachment has an automatic locating device to secure the accessory relative to the container, the locating device comprising one or more slots spaced around an inner surface of the accessory and being adapted to be in register with an edge of the container.

27. An accessory according to claim 1, having a manual sideways push on attachment that resiliently deforms and clips about part of the container where the manual push on attachment has an automatic locating device to secure the accessory relative to the container, the container having a manually operable control used to initiate discharge from the container, the locating device being so made and arranged to automatically set the position of the keeper relative to operation of the container control.

28. An accessory according to claim 1, wherein the spray control is a pump action trigger extending below a spray nozzle the accessory having a manual sideways push on attachment that resiliently deforms and clips about part of the container, and its keeper being so dimensioned and arranged such that its manual push on attachment is located adjacent an upper part of the container and being adjustable so that it does not restrict operation of the control with the user's hand holding the container below the accessory while operating the control, the accessory having a slot which is in register with an edge of the container so that the keeper is automatically set at 90 degrees to a line of operation of the pump action trigger.

29. An accessory according to claim 1, wherein the spray control is a pump action trigger extending below a spray nozzle the accessory having a manual sideways push on attachment that resiliently deforms and clips about part of the container, and its keeper being so dimensioned and arranged such that its manual push on attachment is located adjacent an upper part of the container and being adjustable so that it does not restrict operation of the control with the user's hand holding the container below the accessory while operating the control, the accessory having a lower surface which tapers from a wide can contact surface up to a narrow edge.

30. An accessory according to claim 1, wherein the spray control is a pump action trigger extending below a spray nozzle the accessory having a manual sideways push on attachment that resiliently deforms and clips about part of the container, and its keeper being so dimensioned and arranged such that its manual push on attachment is located adjacent an upper part of the container and being adjustable so that it does not restrict operation of the control with the user's hand holding the container below the accessory while operating the control, the accessory having a slot which is in register with an edge of the container so that the keeper is automatically set at 90 degrees to a line of operation of the pump action trigger, the accessory having a lower surface which tapers from a wide can contact surface up to a narrow edge.
